(19) United States
(12) Patent Application Publication
(10) Pub. No.: US 2015/0283863 A1
(43) Pub. Date: Oct. 8, 2015

(54) EVOLVING TREAD

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Christophe Gayton, Clermont-Ferrand (FR); Hichem Rehab, Clermont-ferrand (FR); Guillaume Demaziere, Clermont-ferrand (FR)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/438,258

(22) PCT Filed: Oct. 18, 2013
(86) PCT No.: PCT/EP2013/071882

§ 371 Date: Apr. 24, 2015

(30) Foreign Application Priority Data
Oct. 24, 2012 (FR) 1260105

(51) Int. Cl. B60C 11/24; B60C 5/00; B60C 11/12

(52) U.S. Cl. CPC B60C 11/24; B60C 11/1263; B60C 5/00

(57) ABSTRACT

Tread for a heavy vehicle tire, having a wearable thickness of material PMU and having at least two main grooves of depth P1 close or equal to PMU, delimiting a raised element, at least one secondary groove of depth P2 less than depth P1, extending throughout the raised element, and having a groove bottom, each of the main and secondary grooves oriented in a circumferential or near-circumferential main direction corresponding to the mean direction of flow of liquid in each groove, a plurality of sipes in the raised element, each comprising lateral parts formed on each side of the secondary groove, and connected by a connecting part formed radially towards the inside of the tread from the bottom of the secondary groove, the connecting part having a sipe portion oriented in the main direction of the secondary groove, making an angle at most equal to 30° with the circumferential direction.

This application is a 371 national phase entry of PCT/EP2013/071882, filed 18 Oct. 2013, which claims benefit of French Patent Application No. 1260105, filed 24 Oct. 2012, the entire content of which is incorporated herein by reference for all purposes.

### BACKGROUND

1. Field

The present disclosure relates to the treads of tires for heavy vehicles, whether these be on the steered axle or on the driven axle, and more particularly to treads comprising at least one groove that disappears before the tread is fully worn away, this full wear corresponding to a legal wear limit beyond which the tire has to be changed or retreaded.

2. Description of Related Art

The applicant companies have developed new tires provided with treads that evolve with tread wear. With such treads, a cavity volume is formed which in the new state opens onto the tread surface of the tread which corresponds to the surface of the tread that is intended to come into contact with the roadway during driving. Also formed in these same treads is a voids volume which does not open onto the tread surface in the new state but after a determined amount of wear. The grooves notably have the function of allowing the water to flow while at the same time keeping the material of which the tread is formed in contact with the said roadway.

In order to improve performance on a wet roadway still further, it is known practice to provide treads with a plurality of sipes that generate additional edge corners, these sipes at least partially closing up as they enter the contact patch so as to limit the loss of rigidity associated with each sipe.

U.S. Pat. No. 2,821,231 discloses a tread comprising four circumferential (i.e. longitudinal) grooves delimiting five ribs. These ribs are provided with a plurality of transversely oriented sipes, these sipes opening into the grooves. Furthermore, these sipes are formed in such a way that—at least in the central part of the tread—they extend radially below the bottoms of the grooves. While such an arrangement is advantageous, the fact nonetheless remains that it is not entirely satisfactory, notably in terms of tread rigidity in the transverse direction.

### DEFINITIONS

The voids surface ratio of a tread pattern is equal to the ratio between the surface area of the voids (essentially formed by grooves) delimited by the raised elements (blocks, ribs) and the total surface area (surface area for contact of the raised elements and surface area of the voids). A low voids ratio indicates a large surface area for contact of the tread and a small surface area of voids between the raised elements.

The voids volume ratio of a tread pattern of a tread in the new state is equal to the ratio between the volume of the voids (notably formed by grooves, cavities) delimited by the raised elements (blocks, ribs) and the total volume of the tread including the wearable volume of material and the volume of the voids. A low voids volume ratio indicates a low volume of voids relative to the volume of the tread. For each level of wear, a voids volume may also be defined.

Equatorial midplane: this is a plane perpendicular to the axis of rotation and passing through those points of the tire that are radially furthest from the said axis.

A block is a raised element formed on the tread and which is delimited by voids or grooves and comprises lateral walls and a contact face intended to come into contact with the roadway.

A rib is a raised element formed on a tread, this element extending in the circumferential direction and making a full circuit of the tire. A rib comprises two lateral walls and a contact face, the latter being intended to come into contact with the roadway during driving.

A radial direction in the present document means a direction which is perpendicular to the axis of rotation of the tire (this direction corresponds to the direction of the thickness of the tread).

A transverse or axial direction means a direction parallel to the axis of rotation of the tire.

A circumferential or longitudinal direction means a direction tangential to any circle centred on the axis of rotation. This direction is perpendicular both to the axial direction and to a radial direction.

Axially towards the outside means a direction oriented towards the outside of the internal cavity of the tire.

Radially towards the inside means a direction oriented towards the axis of rotation of the tire.

The total thickness E of a tread is measured, on the equatorial plane of the tire provided with this tread, between the tread surface and the radially outermost part of the crown reinforcement in the new state.

A tread has a maximum wearable thickness PMU of material that can be worn away during running, this maximum thickness PMU generally being less than the total thickness E.

The conventional conditions under which the tire is run or the normal conditions of use are those defined by the ETRTO standard; these conditions of use specify the reference inflation pressure corresponding to the load bearing capability of the tire as indicated by its load rating and speed code. These conditions of use may also be referred to as “nominal conditions” or “usage conditions”.

A cut generically denotes either a groove or a sipe and corresponds to the space delimited by walls of material that face one another and are distant from one another by a non-zero distance (referred to as the “width of the cut”). What differentiates a sipe from a groove is precisely this distance: in the case of a sipe, this distance is suitable for allowing the opposing walls that delimit the said sipe to come into at least partial contact when the sipe enters the contact patch in which the tire is in contact with the roadway. In the case of a groove, the walls of this groove cannot come into contact with one another under normal running conditions. Each cut has a depth which is less than the thickness E of the tread in order to keep some material radially on top of the crown reinforcement.

### SUMMARY

The present invention, in an embodiment, seeks to obtain a tread for a heavy vehicle tire comprising a tread pattern that is said to evolve and to regenerate as it gradually wears away while at the same time performing the essential functions required for good driving safety, notably good road holding under cornering in the dry and on a road surface covered with standing water, and good wear performance.

To this end, one subject of the invention is a tread having a wearable thickness of material PMU, this thickness PMU being measured between a tread surface as new (this tread surface being intended to be in contact with a roadway) and a wear limit.

This tread comprises:
at least two main grooves of depth P1 close or equal to PMU, these main grooves delimiting a raised element,
in this raised element, at least one secondary groove extending continuously throughout the raised element, this secondary groove having a width L2 and comprising a groove bottom distant from the tread surface in the new state by a distance P2 less than the depth P1 of the main grooves, each of the main and secondary grooves being oriented in a circumferential or near-circumferential main direction and corresponding to the mean direction of a flow of liquid in each groove,
a plurality of sipes formed in this raised element, each of these sipes being oriented obliquely or transversely and comprising lateral parts formed one each side of the secondary groove, these lateral parts being connected to one another by a connecting part, this connecting part being formed radially towards the inside of the tread from the bottom of the secondary groove and up to a depth greater than the depth P2 of the bottom of the secondary groove,
each of these sipes having a maximum depth less than the total thickness E of the tread (this maximum depth being measured at the innermost points of the tread).

This tread is characterized in that the connecting part comprises at least one sipe portion oriented in the direction of the secondary groove, namely making an angle at most equal to 30° with this direction. The direction of the groove is to be interpreted here as meaning the mean direction of a flow of water when driving on a roadway covered with standing water, notably in rainy weather.

For preference, the depth of the connecting parts is at least equal to 90% of the depth P1 of the main grooves.

Advantageously, the tread is such that the depth of the secondary grooves is at least equal to 50% of the wearable thickness of material (PMU) and at most equal to 90% of the same thickness PMU.

In one alternative form of the invention, the tread is characterized in that each sipe portion oriented in or substantially in the main direction of the secondary groove is delimited by opposing walls, these walls being provided with immobilizing means thus limiting the reduction in tread rigidity caused by the presence of the sipes.

It is of course possible to provide all of the walls that delimit each sipe with immobilizing means: zigzag shape, presence of cavities and reliefs that collaborate together.

In order to reduce concentrations of load in the end part of the sipe radially under the bottoms of the secondary grooves it is sensible to make provision for each connecting part to be provided with a widening at its radially inner end. This widening has a width greater than the width of the sipe and may adopt any shape in cross section.

In order to limit the reduction in the rigidity of the tread according to an embodiment of the invention, it is advantageous for the lateral parts to extend as far as a distance measured with respect to the tread surface in the new state which is at most equal to the depth of the secondary groove.

In order for the effect on rigidity to be appreciable, it is sensible for the length in or substantially in the main direction of the secondary groove of each connecting part to be at least equal to 5 mm and more preferably still at least equal to 10 mm.

In another alternative form of the invention, the tread is characterized in that it is provided with at least one legal wear limit indicator device and in that each connecting part of the sipes extends as far as a depth corresponding to the position of the legal wear limit determined by the said device. “Corresponding to the position of the wear limit” means a depth at least equal to this limit.

The latter arrangement is advantageous whenever it is not necessary to create sipes which in all their parts have a depth close to the thickness PMU. In this way, it is possible to limit the reduction in rigidity associated with the presence of a plurality of sipes. The presence of a sipe connecting part opening onto the bottom of the secondary grooves means that once the secondary grooves have disappeared good grip performance in the wet is maintained both in the transverse direction and in the longitudinal direction.

The invention, in an embodiment, also relates to a tire intended to be fitted to a heavy vehicle, this tire being provided with a tread as described in the present document.

Other features and advantages of embodiments of the invention will become apparent from the description given hereinafter with reference to the attached drawings, which by way of nonlimiting examples show some embodiments of the subject matter of the invention.

### BRIEF DESCRIPTION OF THE FIGURES

FIG. 1 depicts a perspective view of a part of a tread according to an embodiment of the invention;

FIG. 2 depicts a plan view of the tread of FIG. 1 in the new state;

FIG. 3 shows a plan view of the tread shown in FIG. 1 after wear has caused a secondary groove to completely disappear;

FIG. 4 shows a perspective view of another alternative form of a tread according to the invention.

### DETAILED DESCRIPTION OF SPECIFIC EMBODIMENTS

To make the figures easier to comprehend, the same reference signs are used for describing alternative forms of the invention where these reference signs refer to elements of the same kind either structurally or functionally.

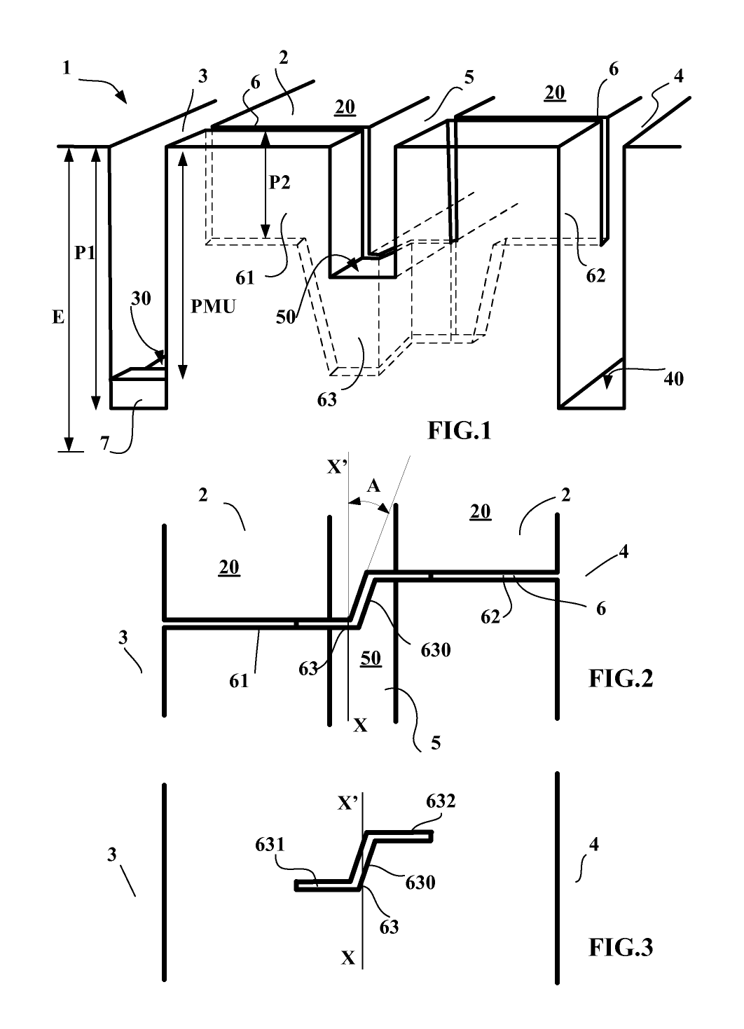

FIG. 1 depicts a perspective view of part of a tread according to an embodiment of the invention. In this first alternative form, a circumferential rib 2 delimited by two circumferential main grooves 3, 4 of depth P1 equal in this instance to 16 mm can be made out on this tread 1. The tread 1 has a total thickness E equal to 22 mm and a thickness PMU to be worn away equal to 14 mm. The thickness PMU is measured from the tread surface 20 in the new state. In general, the wearable thickness PMU is suited to maintaining a sufficient and non-zero thickness between the bottom 30, 40 of the main grooves 3, 4 respectively and a crown reinforcement (not depicted) of the tire on which reinforcement the tread 1 is placed.

This rib 2 comprises a contact face 20 forming part of the tread surface of the tread, this contact face 20 being intended to come into contact with a roadway during driving.

Furthermore, the rib 2 comprises a secondary groove 5 of width L2 and of depth P2 equal in this instance to 12 mm. This secondary groove 5 is continuous and oriented circumferentially and divides the contact face 20 into two parts of equal width. The rib 2 is cut transversely by a plurality of sipes 6 only one of which has been depicted here. Each of these sipes 6 comprises two lateral parts 61, 62 arranged one on each side of the secondary groove 5, these lateral sipe parts having a mean depth equal to the depth P2 of the secondary groove 5.

The main grooves 3, 4 have a mean width equal to 8 mm and the secondary groove 5 has a smaller mean width (here equal to 6 mm). The mean width of the rib 2 is equal on average to 66 mm; this width varies between 65 mm and 68 mm.

The lateral sipe parts 61, 62 are connected together by a sipe forming a connecting part 63 opening onto the bottom 50 of the secondary groove 5 and extending radially towards the inside of the tread. The connecting part 63 extends into the thickness of the tread as far as a level corresponding to the bottoms 30, 40 of the main grooves 3, 4. On the bottom 30 of the groove 3 may be seen an indicator 7 intended to alert the user to a legal wear limit of the tread.

FIG. 2 depicts a plan view of the tread shown in FIG. 1 in the new state. In this FIG. 2, the line of the edge corners formed by the sipe which here has a width of 0.4 mm can be seen on the contact face of the rib. It may be seen that in the bottom 50 of the secondary groove 5, the connecting part 63 of the sipe 6 comprises an oriented part 630 making an angle A at most equal to 30°. The angle A can preferably vary between 14° and 27° according to the spacing of the pattern blocks in the tread pattern. This orientated part 630 is situated in the central part of the bottom of the secondary groove 5 and is extended by lateral parts 631, 632 (shown in FIG. 3) connected to the parts 61 and 62 of the sipe 6 respectively.

FIG. 3 is a plan view of the tread depicted in FIG. 1 and FIG. 2 after wear has caused the secondary groove 5 to completely disappear. It may be noted that only the connecting part 63 of the sipe 6 is still present and opens onto the tread surface in the worn state. The presence of this sipe part 6 reinforces the indication given by the tread wear limit indicator that the tread has not been worn all the way down to its wear limit, requiring it to be withdrawn from service to be renewed by retreading or a new tire.

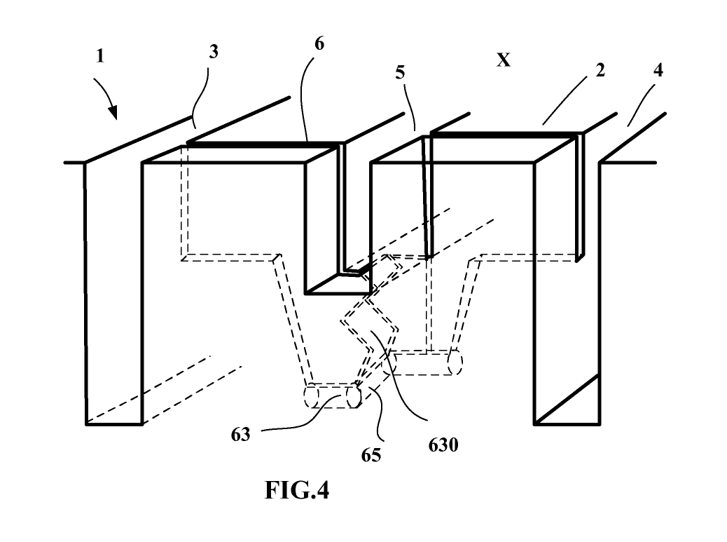

FIG. 4 shows a perspective view of another alternative form of a tread 1 according to the invention. In this alternative form, the connecting part 63 of the sipe 6 comprises a portion 630 aligned in the circumferential direction (corresponding to the direction XX′ of the main and secondary grooves). This portion 630 is formed with a zigzag geometry in the depth direction. Furthermore, and to limit the mechanical effects of concentrated loads that could cause breaks in the material situated near the innermost end of the connecting part, a widening 65 is formed which, in the case depicted, is of a circular shape with a diameter equal to three times the width of the sipe 6.

This same widening may also be formed continuously over the entire length of the bottom of the sipe as required.

The invention that has just been described with the support of the examples depicted should not be restricted to these examples and it is clear that various modifications may be made thereto without however departing from the scope defined by the claims.

1. A tread for a heavy vehicle tire, having a wearable thickness of material PMU and comprising:
at least two main grooves of depth P1 close or equal to PMU, these main grooves delimiting a raised element,
at least one secondary groove of depth P2 less than the depth P1 of the main grooves, this secondary groove extending continuously throughout the raised element and comprising a groove bottom,
wherein each of the main and secondary grooves are oriented in a circumferential or near-circumferential main direction and corresponding to the mean direction of a flow of liquid in each groove,
a plurality of sipes formed in the raised element, each of these sipes comprising lateral parts formed on each side of the secondary groove,
wherein these lateral parts are connected to one another by a connecting part,
wherein this connecting part is formed radially towards the inside of the tread from the bottom of the secondary groove and up to a depth greater than the depth P2, wherein the connecting part comprises at least one sipe portion oriented in the main direction of the secondary groove, namely making an angle at most equal to 30° with the circumferential direction.

2. The tread according to claim 1, wherein the connecting parts have a depth that is at least equal to 90% of the depth P1 of the main grooves.

3. The tread according to claim 1, wherein the depth of the secondary grooves is at least equal to 50% of the wearable thickness of material (PMU) and at most equal to 90% of the same thickness PMU.

4. The tread according to claim 1, wherein each sipe portion oriented in or substantially in the main direction of the secondary groove is delimited by opposing walls, wherein these walls are provided with immobilizing means, thereby limiting a reduction in tread rigidity caused by the presence of the sipes.

5. The tread according to claim 1, wherein each connecting part is provided with a widening at its radially inner end.

6. The tread according to claim 1, wherein the lateral parts extend as far as a distance measured with respect to the tread surface in the new state, which is at most equal to the depth P2 of the secondary groove.

7. The tread according to claim 1, wherein the length of each connecting part oriented in or substantially in the main direction of the secondary groove is at least equal to 5 mm.

8. The tread according to claim 1, wherein the tread further comprises at least one legal wear limit indicator device and wherein each connecting part extends as far as a depth corresponding to the position of the legal wear limit determined by the said device.

9. A tire for a heavy vehicle provided with a tread according to claim 1.
